(19) United States
(12) Patent Application Publication
(10) Pub. No.: US 2025/0307435 A1
(43) Pub. Date: Oct. 2, 2025

(54) DETECTING UNEXPECTED CHANGES TO MANAGED NODES BASED ON REMOTELY-GENERATED VERIFICATION VALUES DERIVED FROM NODE-PROVIDED INTEGRITY MEASUREMENTS

(71) Applicant: Hewlett Packard Enterprise Development LP, Spring, TX (US)

(72) Inventors: Pavan Sridhar Murthy, Bangalore (IN); Deepak Panambur, Bangalore (IN); Adithya KP Simha, Bangalore (IN); Mahendra Jogalekar, Bangalore (IN)

(21) Appl. No.: 18/765,439

(22) Filed: Jul. 8, 2024

(30) Foreign Application Priority Data
Mar. 28, 2024 (IN) 202441025698

(51) Int. Cl. G06F 21/60; G06F 8/65; G06F 21/57

(52) U.S. Cl. CPC G06F 21/604; G06F 8/65; G06F 21/575

(57) ABSTRACT

A process includes accessing from a managed node a plurality of integrity measurements that are generated by the managed node responsive to the managed node changing power states. The process includes determining whether the managed node has unexpectedly changed. Determining whether the managed node has unexpectedly changed includes identifying an algorithm that corresponds to the managed node. Determining whether the managed node has unexpectedly changed further includes applying the algorithm to the integrity measurements to generate an observed verification value for the managed node. Determining whether the managed node has unexpectedly changed further includes comparing the observed verification value with an expected verification value for the managed node. The process includes initiating a responsive action in response to determining that the managed node has unexpectedly changed.

### BACKGROUND

A computer system may be subject to a security attack in which a malevolent actor seeks to access information that is stored in the computer system or harm components of the computer system. A computer system may have various defenses for purposes of preventing security attacks or at least mitigating the degree of harm inflicted by security attacks.

### BRIEF DESCRIPTION OF THE DRAWINGS

FIG. 1 is a block diagram of a computer network having a start verification service that detects unauthorized changes to managed nodes and accommodates authorized updates to the managed nodes according to an example implementation.

FIG. 2 is an illustration of a managed node record used by the start verification service according to an example implementation.

FIG. 3 is a sequence flow diagram illustrating communications and actions associated with determining and verifying an observed start value for a managed node according to an example implementation.

FIG. 4 is a sequence flow diagram illustrating communications and actions associated with updating an expected start value for a managed node according to an example implementation.

FIG. 5 is a sequence flow diagram illustrating communications and actions associated with updating a start value derivation algorithm for a managed node according to an example implementation.

FIG. 6 is a flow diagram depicting a process to detect and manage an unexpected change to a managed node according to an example implementation.

FIG. 7 is an illustration of machine-readable instructions that, when executed by a machine associated with an attestation service, cause the machine to determine whether a managed node has unexpectedly changed according to an example implementation.

FIG. 8 is a block diagram of a computer system that includes a hardware processor to detect that a managed node has unexpectedly changed according to an example implementation.

### DETAILED DESCRIPTION

The unauthorized modification of a compute node (e.g., a server), such as the unauthorized modification of the compute node's firmware, hardware and/or configuration, may pose security concerns for the compute node as well as pose security concerns for other entities that interact with the compute node. The unauthorized modification of a compute node may be attributable to any of a number of reasons, such as a change in furtherance of a security attack on the compute node. Even if an unauthorized modification is for benign purposes, the modification may have unattended consequences, such as the inadvertent introduction of a malevolent agent, security vulnerability, performance issue, or other issue that negatively impacts the compute node. Accordingly, it may be beneficial to assess, when a compute node boots, whether the compute node has unexpectedly changed. Making this assessment at boot time allows timely responsive actions to be taken to prevent or at least mitigate potential harm that may be inflicted by the node. For example, for client security, it may be beneficial to prevent a compute node that has unexpectedly changed from processing client workloads. As other examples, it may be beneficial to isolate, or quarantine, a compute node that has unexpectedly changed from a computer network to protect other entities of the network.

Remote attestation is a security solution for verifying whether a compute node is considered trustworthy. In the context used herein, a compute node being considered “trustworthy” refers to the compute node behaving consistently in expected ways. Moreover, in the context used herein, a compute node being considered “trustworthy” refers to the compute node having an expected state, such as one or multiple of an expected inventory or an expected configuration. Stated differently, a compute node that has unexpectedly changed is considered to be untrustworthy. The evaluation of the compute node's trustworthiness may be based on integrity measurements of the compute node. For example, a compute node may undergo a measured boot in which the compute node acquires integrity measurements of itself. The integrity measurements serve as a basis for an attestation, or evidence, that the compute node, as an attestor, sends to a remote verifier. The remote verifier determines whether the evidence that is provided by the compute node is expected. If the evidence that is provided by the compute node is expected, then the compute node passes attestation and is considered trustworthy. Otherwise, the compute node fails attestation and is considered untrustworthy.

In a more specific example, during a measured boot of a compute node, pre-boot components of the compute node may acquire integrity measurements. The integrity measurements may take on any of a number of different forms, such as hashes of firmware driver and application images, configuration settings, boot policy parameters, or other attribute quantifications of the compute node. The pre-boot components of the compute node may extend platform configuration registers (PCRs) of the node with the integrity measurements. The PCRs may be part of the compute node's trusted platform module (TPM).

In one approach to remote attestation, in response to a challenge from a remote verifier, the TPM of a compute node generates an attestation, called a “TPM quote.” A TPM quote is a signed composite hash (the “observed composite hash”) of selected PCR values. The remote verifier may, in response to receiving a TPM quote, compare the corresponding observed composite hash to an expected composite hash. If the expected and observed composite hashes are the same, then the compute node passes attestation and is considered trustworthy. This approach to remote attestation, however, may encounter challenges when permitted, or authorized, updates are made to a compute node. An authorized update to a compute node changes the node's PCR content and may correspondingly change the composite hash that corresponds to the TPM quote. If the composite hash that is expected by the verifier is not changed to reflect the authorized update, then the compute node may fail attestation.

In one approach to accommodate an authorized update to a compute node, a customer may be prompted, after the update, to override an attestation failure. The customer may, however, be unaware of the intricate details of the compute node and accordingly, may not have adequate knowledge to assess whether an unauthorized modification has also been made to the compute node after the compute node's last validated boot. In another approach, an update to the expected composite hash may be preapproved when an authorized modification has been made to the compute node. This approach also fails to, however, consider whether an unauthorized modification has also been made to the compute node after the compute node's last validated boot. Accordingly, either of these approaches may lead to a compromised compute node.

In accordance with example implementations that are described herein, a remote attestation service, called a “remote start verification service,” determines whether or not a particular compute node (called a “managed node” herein) is trustworthy based on PCR values of the node. In an example, the start verification service may be a cloud-based service (e.g., an “as-a-Service”). In accordance with example implementations, the start verification service applies an algorithm (called a “start value derivation algorithm” herein) to the compute node's PCR values to derive an observed, verifiable value (called an “observed start value” or “observed verification value” herein) for the managed node. The observed start value may be considered evidence, or an attestation, for the managed node. For purposes of the managed node passing attestation and being considered trustworthy, the start verification service expects the observed start value to be the same as an expected value (called an “expected start value” or “expected verification value” herein). Otherwise, if the expected and observed start values are not the same, the managed node fails attestation and is not considered trustworthy. The start verification service derives the expected start value by applying the same start value derivation algorithm to expected PCR values for the managed node. The start verification service derives the expected PCR values based on the service's knowledge of the managed node's inventory and configuration (referred to as an “expected inventory” and an “expected configuration” herein).

More specifically, in accordance with example implementations, during each boot of a managed node, a firmware-based measurement agent of the managed node acquires integrity measurements of the node and extends PCRs of the node with the integrity measurements. At the conclusion of the boot, the firmware-based measurement agent stores the PCR values in a secure repository that is managed by a baseboard management controller of the managed node. These PCR values are referred to herein as the “observed PCR values.” Through an API call to the baseboard management controller, the start verification service retrieves the observed PCR values from the node's secure repository and applies a start value derivation algorithm to the PCR values for purposes of determining an observed verification start value for the managed node. The start verification service, based on the node's expected inventory and configuration, may determine expected PCR values for the managed node and apply the same start derivation algorithm to the expected PCR values for purposes of deriving the expected start value.

The start verification service, in accordance with example implementations, has knowledge of any authorized updates to the managed node, and the remote start verification service accommodates such updates. More specifically, in accordance with example implementations, the start verification service adapts to an authorized update by updating any affected expected PCR value(s) and reapplying the start value derivation algorithm to the updated PCR value(s) to derive the updated expected start value.

Therefore, the start verification service adapts the expected start value to track authorized changes, or modifications, to the managed node. This tracking, in turn, allows the remote start verification service to efficiently and accurately detect when any unauthorized change has been made to the managed node. Moreover, attributes of the start value derivation algorithm, such as the particular PCR indices and the number of PCRs processed by the algorithm, control the degree of security protection for a managed node. In this way, different start value derivation algorithms corresponding to different security policies may be used for different managed nodes.

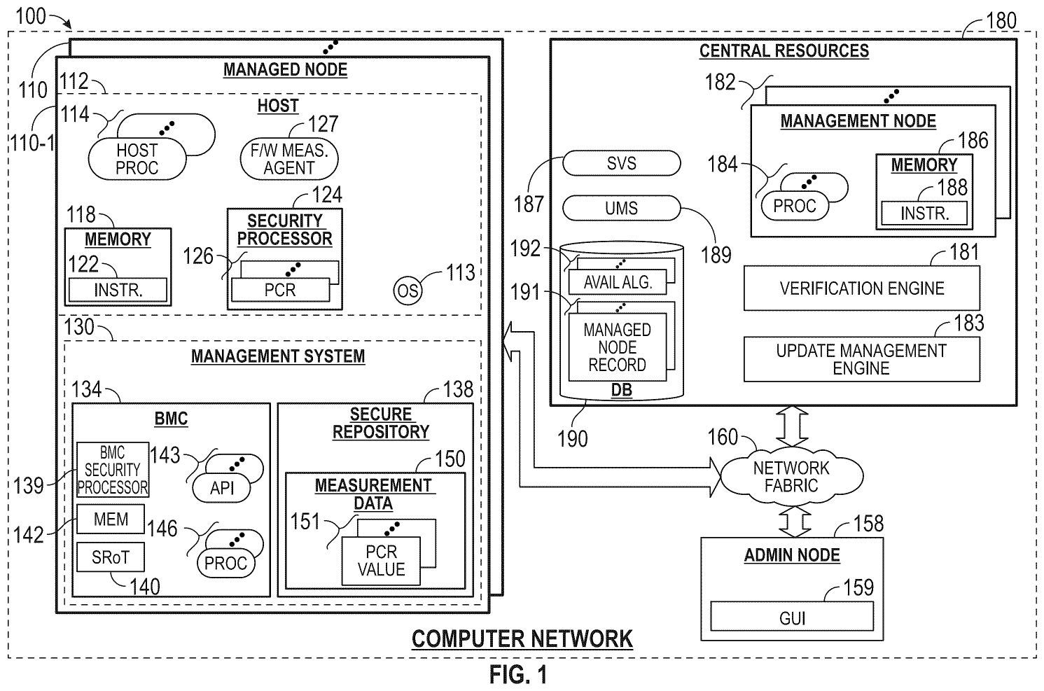

Referring to FIG. 1, as a more specific example, in accordance with some implementations, a computer network 100 includes one or multiple local compute nodes 110, which are managed by remote management services. The remote management services are provided by central resources 180 and in accordance with example implementations, include an update management service 189 (labeled as “UMS 189” in FIG. 1) and a start verification service 187 (labeled as “SVS 187” in FIG. 1). The local compute nodes 110 are referred to as “managed nodes 110” herein. In this context, “remote” and “local” are relative terms, designating whether entities or services are located in the same or different networks. In an example, a local entity, such as a managed node 110, is located in a different network than a remote entity, such any of the entities of the central resources 180.

As depicted in FIG. 1, the managed nodes 110 and the central resources 180 may be coupled together by network fabric 160. In accordance with example implementations, the network fabric 160 may be associated with one or multiple types of communication networks, such as (as examples) Fibre Channel networks, Compute Express Link (CXL) fabric, dedicated management networks, local area networks (LANs), WANs, global networks (e.g., the Internet), wireless networks, or any combination thereof.

FIG. 1 depicts components of an exemplary managed node 110-1. Other managed nodes 110 may have similar components and architectures as the managed node 110-1, in accordance with example implementations.

In an example, multiple managed nodes 110 may be co-located in a data center. In another example, multiple managed nodes 110 may be co-located in an office building or campus geographical site that is affiliated with a local branch network. In another example, the computer network 100 may include multiple clusters of managed nodes 110 (e.g., clusters located in respective local networks).

In an example, the central resources 180 may be cloud-based resources that are located in one or multiple data centers. In an example, the central resources 180 may be distributed across one or multiple geographical locations and/or availability zones. In an example, the central resources 180 may be separate from a local branch network that contains the managed nodes 110 and may be part of a larger wide area network (WAN), such as the Internet. In an example, the update management service 189 and the start verification service 187 may be “as-a-Services.” In an example, the update management service 189 and the start verification service 187 may each be a subscription-based Software-as-a-Service (SaaS).

In the context that is used herein, a “node,” such as managed node 110-1, refers to a processor-based entity that has an associated set of hardware and software resources. In an example, the managed node 110-1 may be associated with a computer platform. In this context, a “computer platform” is a processor-based electronic device, which has an associated operating system. As examples, a computer platform may be a standalone server; a distributed server; a rack-mounted server module; an edge processing, rack-mounted module; a blade server; a blade enclosure containing one or multiple blade servers; a client; a thin client; a desktop computer; a portable computer; a laptop computer; a notebook computer; a tablet computer; network device; a network switch, a gateway device, a smartphone; a wearable computer; or another processor-based platform.

In an example, the managed node 110-1 may be an actual, physical computer platform. In an example, the managed node 110-1 may correspond to an entire bare metal server. In another example, the managed node 110-1 may correspond to a partition of bare metal server. In another example, the managed node 110-1 may be virtual. In an example, the managed node 110-1 may be an abstraction of hardware and software resources of a corresponding physical computer platform, such as a virtual machine that is hosted on the computer platform. In an example, a particular physical computer platform may host multiple virtual machines that correspond to multiple managed nodes 110. As can be appreciated, the managed nodes 110 may correspond to one or multiple physical computer platforms.

As depicted in FIG. 1, the managed node 110-1 is associated with a host 112 and a management system 130. In this context, a “host” refers to a collection of components, such as one or multiple hardware host processors 114 and a system memory 118, which are constructed to host and provide an operating system 113. In this context, an “operating system” refers to software that manages hardware and software resources (e.g., virtual or physical hardware) of the managed node 110-1 as well as provides services for other software components (e.g., applications) that execute on the managed node 110. In examples, the operating system 113 may be a LINUX operating system, a WINDOWS operating system, a MAC operating system, a FREEBSD operating system, a hypervisor (e.g., an ESXi, KVM or Hyper-V hypervisor) or another operating system.

The host processor 114 is a physical, or actual, processor that executes machine-readable instructions (e.g., software and firmware instructions). In examples, a host processor 114 may include one or multiple central processing unit (CPU) cores, or one or multiple graphics processing unit (GPU) cores. In other examples, a host processor 114 may be a hardware entity that does not execute machine-readable instructions, such as a programmable logic device (e.g., a complex programmable logic device (CPLD)), an application specific integrated circuit (ASIC) or a field programmable gate array (FPGA).

The system memory 118 and other memories discussed herein are non-transitory storage media that may be formed from semiconductor storage devices, memristor-based storage devices, magnetic storage devices, phase change memory devices, a combination of devices of one or more of these storage technologies, and so forth. The system memory 118 may represent a collection of memories of both volatile memory devices and non-volatile memory devices. In accordance with example implementations, the system memory 118 may store machine-readable instructions 122. The instructions 122 may be associated with any of a number of different software and/or firmware programs (e.g., an operating system, application programs, firmware-based preboot services, firmware-based boot services, drivers, or other programs) that are executed by the host processor(s) 114.

In an example, in the managed node's pre-boot environment, the instructions 122 may include instructions corresponding to an Unified Extensible Firmware Interface (UEFI) image loader. In an example, the instructions 122 may include instructions corresponding to firmware-based measuring agent (called the “firmware measuring agent 127” herein), such as a measuring agent of an UEFI image loader. As further described herein, the firmware measuring agent 127, in a pre-boot environment of the managed node 110-1, acquires integrity measurements of the managed node 110-1 and extends PCRs 126 with the integrity measurements.

The memory 118 may also store data that may be associated with any of a number of different data types. In examples, the data may represent files, data structures, libraries, data inputs, user inputs, intermediate processing results, arrays, final processing results, kernel space data structures or data corresponding to other data types.

In the context that is used herein, a “management system” refers to a collection of one or multiple components, which provide management services for the managed node 110-1, including managing the host 112. In accordance with example implementations, the management system 130 includes a management controller. In an example and as depicted in FIG. 1, the management controller may be a baseboard management controller 134. In another example, the management controller may be a chassis management module.

The start verification service 187, in accordance with example implementations, is a remote attestation service that determines, based on expected PCR values 151 retrieved from the managed node 110-1, an observed start value for the managed node 110-1. The start verification service 187 verifies whether the observed start value is as expected. More specifically, in accordance with example implementations, the start verification service 187, responsive to a boot of the managed node 110-1, accesses the managed node 110-1 to retrieve observed PCR values 151. In an example, the observed PCR values 151 correspond to respective PCRs 126 and represent PCR content that exists at the conclusion of the managed node's boot before control is transferred to the operating system 113. In an example, during the boot of the managed node 110-1, the firmware measuring agent 127 acquires integrity measurements of various attributes of the measurement node 110-1, such as measurements of firmware images, hardware components and configuration values of the node 110-1. The firmware measuring agent 127, in accordance with example implementations, extends PCRs 126 with the integrity measurements, and responsive to the conclusion of the boot (e.g., at the transition of the pre-boot environment to post-boot environment when control is transferred to the operating system), the firmware measuring agent 127 copies selected PCR content (corresponding to selected PCR indices) to a secure repository 138 of the management system 130. In an example, the firmware measuring agent 127 copies content from selected PCRs 126 and stores the content as respective observed PCR values 151 in the secure repository 138. The PCR values 151 are collectively referred to herein as observed integrity measurement data, or “measurement data 150.”

The boot of the managed node 110-1 is an example of the managed node 110-1 changing power states. In this context, the managed node 110-1 changing power states refers to the managed node 110-1 transitioning from one power consumption level to another power consumption level. In an example, the power consumption level may correspond to a particular Advanced Configuration and Power Interface (ACPI) power state of the managed node 110-1, and the managed node 110-1 changing power states corresponds to the managed node 110-1 changing from one ACPI power state to another ACPI power state. For a boot, the managed node 110-1 may transition from an ACPI S5 power state, the off state (with no power consumption except for possibly device(s) powered by standby power for wakeup purposes), to an ACPI S0 state, the run state.

The managed node 110-1 may change power states unrelated to a boot of the managed node 110-1, which, in accordance with example implementations, may prompt the start verification service 187 to determine and verify an observed start value for the managed node 110-1. In an example, the verification start service 187 may determine and verify an observed start value for the managed node 110-1 responsive to the managed node 110-1 transitioning from an ACPI S1 state, the suspend state, back to the ACPI S0 state, the run state. In another example, the verification start service 187 may determine and verify an observed start value for the managed node 110-1 responsive to the managed node 110-1 transitioning to the ACPI S0 state, the run state, from a sleep state (e.g., an ACPI S2 or S3 state). In another example, the verification start service 187 may determine and verify an observed start value for the managed node 110-1 responsive to the managed node 110-1 transitioning to the ACPI S0 state, the run state, from the ACPI S4 state, the suspend, or hibernation, state. In accordance with further implementations, the power state of the managed node 110-1 may be a power consumption classification other than an ACPI state.

Responsive to accessing the observed PCR values 151, the start verification service 187 applies a start value derivation algorithm to the observed PCR values 151 to generate an observed start value for the managed node 110-1. The observed start value may be considered a verification value, or verifiable value, from which the start verification service 187 may determine whether the managed node 110-1 has unexpectedly changed. In this context, a managed node “unexpectedly changing” refers to an unauthorized update, or modification, being made to the inventory (e.g., hardware, firmware and/or software) or configuration of the managed node. Authorized updates to the managed node 110-1 may occur for any of a number of reasons, such as bug fixes, security patches or feature enhancements. Some unauthorized updates may be nefarious in nature, such as updates to further a security attack, exploit a security vulnerability or otherwise negatively impact the managed node. Some unauthorized updates may be not intended to negatively affect a managed node, but the updates may nevertheless introduce a security vulnerability, introduce a malevolent agent, impact the node's performance or result in another harmful impact on the managed node.

If the start verification service 187 determines, based on the observed start value, that the managed node 110-1 has unexpectedly changed, then the start verification service 187 may initiate one or multiple responsive actions. Such responsive action(s) may limit potential harm caused by the managed node 110-1. Moreover, such responsive action(s) may counter potential tampering with the managed node 110-1 and protect other components of the computer network 100 due to the tampering. In an example, the start verification service 187 may, responsive to determining that managed node 110-1 has unexpectedly changed, send an alert message to the baseboard management controller 134 for purposes of preventing the managed node 110-1 from transferring control to the operating system 113. In another example, a responsive action may include the start verification service 187 sending an alert message to the baseboard management controller 134 for purposes of causing the baseboard management controller 134 to perform one or multiple other actions. In examples, the baseboard management controller 134 may undertake such actions as quarantining the managed node 110-1 from the computer network 100, powering down the managed node 110-1 or imposing a constraint for system administrator approval before the node 110-1 is allowed to boot again or transfer control to the operating system 113. In other examples, the start verification service 187 may, responsive to determining that managed node 110-1 has unexpectedly changed, send an alert message to a system administrator or send an alert to an administrative dashboard.

In accordance with example, implementations, for purposes of determining whether the managed node 110-1 has unexpectedly changed, the start verification service 187 compares the observed start value (calculated from the observed PCR values 151) to an expected start value for the managed node 110-1. In accordance with example implementations, if the observed start value is different from the expected start value, then the start verification service 187 determines that the managed node 110-1 has unexpectedly changed.

In accordance with example implementations, the start verification service 187 determines expected PCR values for the managed node 110-1 based on an expected inventory and an expected configuration for the managed node 110-1. In this manner, based on the expected inventory and expected configuration for the managed node 110-1, the start verification service 187 determines expected integrity measurements for the managed node 110-1, and from the expected integrity measurements, the start verification service 187 derives the expected PCR values. The start verification service 187 further determines, in accordance with example implementations, an expected start value for the managed node 110-1 by applying the start value derivation algorithm to the expected PCR values.

The start value derivation algorithm that the start verification service 187 applies to generate the observed and expected start values may take on one of many different forms. Moreover, in accordance with example implementations, the start verification service 187 may use different verified start derivation algorithms for different managed nodes 110, which allows the implementation of different security policies for the managed nodes 110. In an example, different start value derivation algorithms (corresponding to different managed nodes 110) may target different PCR indices. For example, algorithm A (corresponding to a particular managed node 110) may combine PCR values 151 corresponding to PCR indexes 1, 2 and 3; and algorithm B (corresponding to another managed node 110) may combine PCR values 151 corresponding to PCR indexes 1, 2, 3, 4 and 7. In general, a start value derivation algorithm that considers a larger number of PCRs corresponds to a security policy with a relatively stricter control (as compared to an algorithm considering a lesser number of PCRs) on how the managed node 110-1 may be updated. Moreover, a particular start derivation algorithm may target a particular subset of PCR indices, to correspond to particular integrity measurements of importance for a particular security policy. In another example, different start value derivation algorithms (corresponding to different managed nodes 110) may combine PCR values 151 in different ways. In an example, a particular start value derivation algorithm may concatenate PCR values. For example, a start value derivation algorithm may derive an observed start value according to “PCR Value for PCR Index 1 | | PCR Value for PCR Index 2 | | PCR Value for PCR Index 3,” where “| |” represents a concatenation operator. In another example, a particular start value derivation algorithm may hash a particular concatenation of PCR values that correspond to certain PCR indices. In another example, a particular algorithm may first hash PCR values corresponding to certain PCR indices, concatenate these hashes together and then hash the concatenated hashes.

In the context that is used herein, a “hash” (which may also be referred to by such terminology as a “digest,” “hash value,” or “hash digest”) is produced by the application of a cryptographic hash algorithm to an input value. Applying a hash algorithm to an input value may also be referred to herein as determining a “hash” of the input value or “hashing” the input value. A cryptographic hash algorithm receives an input value, and the cryptographic hash algorithm generates a hexadecimal string (the digest, or hash) to match the input value. In an example, the input value may include a string of data (for example, a data structure in memory denoted by a starting memory address and an ending memory address). In such an example, based on the string of data, the cryptographic hash algorithm outputs a hexadecimal string (the digest, or hash). Any minute change to the input value alters the output hexadecimal string. In examples, the cryptographic hash function may be a secure hash algorithm (SHA), a Federal Information Processing Standards (FIPS)-approved hash algorithm, a National Institute of Standards and Technology (NIST)-approved hash algorithm, or any other cryptographic hash algorithm. In some examples, instead of a hexadecimal format, another format may be used for the string.

For purposes of identifying the particular start value derivation algorithm to be used for the managed node 110-1, the start verification service 187 may, in accordance with example implementations, search a data store, such as one or multiple databases 190, for a record 191 that corresponds to the managed node 110-1. The record 191 contains data that identifies the start value derivation algorithm for the managed node 110-1. In this manner, the database(s) 190, in accordance with example implementations, may contain records 191 for respective managed nodes 110. In an example, a record 191 may contain data representing an identifier for a particular start value derivation algorithm. In another example, a record 191 may contain data that represents a particular security policy for the corresponding managed node 110, and the start verification service 187 identifies the appropriate start value derivation algorithm based on the identified security policy for the managed node 110-1. The database(s) may contain other information, such as data 192 that represents available, or candidate, start value derivation algorithms for the managed nodes 110, as further described herein.

The managed node 110-1, in accordance with example implementations, performs a sequence of integrity measurements during a measured boot to establish a chain of trust for the managed node 110-1. In an example, the beginning, or root, of the chain of trust may correspond to a hardware-based core root of trust for measurement, which measures and loads an initial set of firmware. In another example, the root of the chain of trust may correspond to a firmware-based core root of trust for measurement. Regardless of the particular core root of trust for measurement, the initial set of firmware may then be executed, and as part of this execution, the initial set of firmware measures and loads a next set of firmware. Pursuant to the measured boot, the construction of the chain of trust continues, with each component measuring the next component to be loaded and executed. The managed node 110-1 extends the PCRs 126 with the integrity measurements taken during the measured boot to create a corresponding set of PCR values that correspond to the chain of trust.

In this context that is used herein, “extending” a PCR with an integrity measurement refers to replacing a current value stored in the PCR with a new value that is based on a combination of the current value and the integrity measurement. In an example, extending a PCR with an integrity measurement may include concatenating a current value stored in the PCR with the integrity measurement to form a concatenated value, applying a hash algorithm to the concatenated value to form a hash value, and storing the hash value in the PCR. In an example, a PCR may be extended through the execution of a PCR Extend command that has such arguments as a numerical PCR identifier, or index; and a particular cryptographic hash algorithm identifier. The value that is stored in a PCR may be viewed as a cryptographic ledger in that the value is a result of the PCR being extended with a set of integrity measurements in a particular order to arrive at the value. The value that is stored in a PCR may also be considered an integrity measurement.

A PCR 126 may be associated with one or multiple PCR banks. In this context, a “PCR bank” refers to the association of a PCR with a particular hash algorithm. Multiple PCRs 126 may be associated with the same PCR bank. A PCR 126 may be identified and referenced by an associated PCR index.

The PCRs 126, in accordance with example implementations, correspond to a secure memory of a security processor 124 of the managed node 110-1. The security processor 124, in general, may be used to provide cryptographic services for the managed node 110-1 and securely store cryptographic artifacts (e.g., secure boot variables, hashes, digital certificates, passwords, and so forth) for the managed node 110-1. In an example, the security processor 124 may be a TPM. In an example, the TPM may be a physical hardware component that is mounted to a motherboard of the managed node 110-1. In another example, the security processor 124 may be a virtual TPM (vTPM). In another example, the security processor 124 may be a firmware TPM (fTPM).

In accordance with some implementations, the security processor 124 may be constructed to perform one or multiple trusted computing operations that are described in the Trusted Platform Module Library Specification, Family 2.0, Level 00, Revision 01.59 (November 2019), published by the Trusted Computing Group (hereinafter called the “TPM 2.0 Specification”). In accordance with further implementations, the security processor 124 may perform one or multiple trusted computing operations that are not described in the TPM 2.0 Specification.

The PCRs 126, in accordance with some implementations, may have usages that are described in the TCG PC Client Platform Firmware Profile Specification, Level 00, Version 1.06, Revision 52 (Dec. 4, 2023), published by the Trusted Computing Group. The PCR usages are associated with corresponding PCR indices. In an example, PCR Index 1 may correspond to a PCR 126 that is extended with integrity measurements of a BIOS, host platform extensions, embedded option ROMs and platform initialization drivers. In another example, PCR Index 2 may correspond to a PCR 126 that is extended with one or multiple integrity measurements of a platform configuration. In another example, PCR Index 3 may correspond to a PCR 126 that is extended with integrity measurements of UEFI driver and UEFI application images. In another example, PCR Index 4 may correspond to a PCR 126 that may be extended with an integrity measurement of a boot manager image and may further be extended with a number of boot attempts. In another example, PCR Index 5 may correspond to a PCR 126 that is extended with an integrity measurement of a boot manager configuration and may further be extended with a configuration of a drive partition table. In another example, PCR Index 6 may correspond to a PCR 126 that is extended with one or multiple platform integrity measurements. In another example, PCR index 7 may correspond to integrity measurements of parameters of an UEFI secure boot policy.

In accordance with example implementations, at the conclusion of the boot of the managed node 110, the firmware measuring agent 127 measures an operating system boot loader and extends the appropriate PCR 126 (e.g., PCR 126 corresponding to PCR Index 4) with the integrity measurement to complete the construction of the chain of trust. The firmware measuring agent 127 may then, in accordance with example implementations, copy selected PCR content to the secure repository 138 of the managed node 110-1. The selected PCR content, in accordance with example implementations, corresponds to a selected set of PCR indices such that the observed PCR values 151 correspond to respective PCR indices. Depending on the particular implementation, the observed PCR values 151 may correspond to all of the PCRs 126 or a selected subset of the PCRs 126. The start verification service 187, as described further herein, may access the PCR values 151 and apply the appropriate start value derivation algorithm to the PCR values 151 to derive an observed start value for the managed node 110-1.

The PCR values 151 are the result of integrity measurements for a managed node 110-1 that has a particular inventory and particular configuration. In the context used herein, an “inventory” of the managed node 110-1 refers to a collection of components that are associated with the managed node 110-1. In an example, the inventory may include one or multiple firmware components. In examples, the firmware components may include one or multiple pre-boot firmware images (e.g., an UEFI image) and a basic input/output system (BIOS) image). In another example, the inventory may include a pre-EFI (PEI) image. In other examples, the inventory may include a runtime services firmware image (e.g., an UEFI image), driver images (e.g., a Peripheral Component Interconnect (PCIe) image) (or “option ROM images”) loaded from peripheral devices, UEFI driver images and UEFI application images. Each of these firmware components are associated with respective specific identifying information, such as a manufacturer, a release date and a version number. Moreover, each of these firmware components may be associated with a particular expected measurement.

The inventory of the managed node 110-1 may include one or multiple hardware components. In an example, the inventory of the managed node 110 may include one or multiple host processors 114. The host processors 114 may include one or multiple (CPU) processing cores and/or one or multiple graphics processing unit (GPU) cores. A particular host processor 114 may be affiliated with identifying information, such as a manufacturer, a family type, a model and/or identifier. This hardware processor-identifying information, in turn, may be measured by the managed node 110-1 and as such, may be represented in a particular observed PCR value 151. In another example, the inventory of a managed node 110 may include specific memory devices, such as one or multiple memory modules that have corresponding identifying information. In other examples, the inventory of the managed node 110-1 may include one or multiple peripheral devices that have corresponding identifying information. The memory module-identifying information, as well as the peripheral device-identifying information, may be measured by the managed node 110-1 and correspondingly, be represented in one or multiple PCR values 151.

In another example, the inventory for a managed node 110-1 may be characterized as being associated with a particular computer platform category. In an example, the inventory for the managed node 110 may correspond to a particular server. In an example, the managed node 110-1 may correspond to a particular server model, such as a “Generation 2” XYZ server. In an example, the managed node 110-1 may measure one or multiple aspects of the platform category, and correspondingly, the measurement(s) may be represented in a particular PCR value 151.

In the context that is used herein, the “configuration” of the managed node 110-1 refers to a collection of settings of or for the managed node 110-1. In an example, the configuration may include settings for the inventory present during a boot of the managed node 110-1. In an example, the configuration includes data representing flags for respective firmware components of the managed node 110-1 that are and are not measured during a boot of the managed node 110-1. In an example, the managed node 110-1 may measure such flags during the boot of the managed node 110-1 and the corresponding integrity measurements may be represented by a particular PCR value 151. In an example, the configuration includes BIOS settings, and a PCR value 151 may be the result of one or multiple BIOS setting measurements. In an example, the configuration includes one or multiple EFI variables, and a particular PCR value 151 may be the result of integrity measurement(s) of one or multiple EFI variables. In an example, the configuration includes content of a SMBIOS table, and a PCR value 151 may be the result of an integrity measurement of such content. In an example, the configuration includes content of an ACPI table, and a particular PCR value 151 may be the result of an integrity measurement of such content. In an example, the configuration includes content of an UEFI runtime services table, and a particular PCR value 151 may be the result of an integrity measurement of such content. In an example, the configuration includes content of an UEFI boot services table, and a particular PCR value 151 may be the result of an integrity measurement of such content.

In another example, the configuration may include one or multiple settings for a particular peripheral device associated with a managed node 110-1, and a PCR value 151 may be the result of an integrity measurement of one or multiple such settings. In an example, the configuration may include one or multiple setting for a host bus adapter, such as a redundant array of inexpensive disks (RAID) type or drive assignments. In another example, the configuration may include one or multiple settings for a smart input/output (I/O) peripheral device, such as a number of I/O space base address registers (BARs), a number of memory space BARs and/or a total number of BARs for the device.

In accordance with example implementations, the start verification service 187 determines expected integrity measurements for the managed node 110-1 (e.g., determines expected PCR values 151) and applies a start value derivation algorithm to the expected integrity measurements for purposes of determining an expected start value for the managed node 110-1. In accordance with example implementations, the start verification service 187 determines the expected integrity measurements based on an expected inventory and an expected configuration for the managed node 110-1. For this purpose, the start verification service 187 may access, from one or multiple databases, one or multiple records that correspond to the managed node 110-1. For the examples described herein, this information is contained in a single record 191. However, as can be appreciated, the information may be contained from multiple records in one or multiple databases. In accordance with example implementations, the start verification service retrieves a record 191 that corresponds to the managed node 110-1 and contains data representing the expected inventory and expected configuration for the managed node 110-1. Moreover, in accordance with example implementations, the start verification service 187 may further retrieve data from the record 191 that represents a start value derivation algorithm that is to be used for the managed node 110-1. Therefore, from the record 191, the start verification service 187 may derive expected integrity measurements for the managed node 110-1. Moreover, the start verification service 187 may derive an expected start value for the managed node 110-1 as well as update the expected start value for the managed node 110-1 responsive to authorized updates to the inventory and/or configuration of the managed node 110-1.

Responsive to the managed node 110-1 changing power states, the start verification service 187 accesses the record 191 corresponding to the managed node 110-1 to retrieve the expected start value. The update management service 189 may notify the start verification service 187 when a particular managed node 110 is updated (e.g., firmware is upgraded on the managed node). In this way, when the managed node 110 is updated, the start verification service 187 may recalculate the expected start value for the managed node 110 and store the expected start value in the database(s) 190. For this purpose, in accordance with example implementations, the start verification service 187 identifies the particular expected integrity measurement(s) that changed due to the authorized update, and the start verification service 187 appropriately recalculates the expected integrity measurement(s). The start verification service 187 may then recalculate the affected PCR value(s) 151. The start verification service 187 may then apply the appropriate start value derivation algorithm to the updated PCR values 151 to derive a new, or updated, expected start value for the managed node 110-1. In a similar manner, responsive to a different start value derivation algorithm being selected for the managed node 110, the start verification service 187 may recalculate the expected start value for the managed node 110 and store the recalculated expected start value in the database(s) 190.

In accordance with example implementations, the start verification service 187 communicates with the management system 130 of the managed node 110-1 for purposes of accessing the secure repository 138. In an example, the secure repository 138 may be formed from non-volatile memory devices that are mounted to a motherboard of a computer platform that is associated with the managed node 110-1. In an example, the secure repository 138 may include NAND flash memory devices and correspondingly be referred to as a “NAND repository” of the managed node 110-1. In an example, in accordance with some implementations, the baseboard management controller 134 may control access to the secure repository 138. In an example, the baseboard management controller 134 may limit access to the secure repository 138 to certain authorized entities, including the firmware measuring agent 127 and the start verification service 187. In an example, the baseboard management controller 134 may access the secure repository 138 on behalf of an authorized entity to retrieve or store data stored in the secure repository 138.

In accordance with example implementations, the firmware measuring agent 127 and the start verification service 187 may each access the secure repository 138 by making calls to one or multiple application programming interfaces (APIs) 143 of the baseboard management controller 134. For example, the start verification service 187 may submit an API call (e.g., a REST API call) to the baseboard management controller 134 to read the observed PCR values 151. In an example, the start verification service 187 may submit an API call responsive to the start verification service 187 being notified to a boot of the managed node 110-1. In another example, the start verification service 187 may regularly (e.g., pursuant to a schedule) poll the secure repository 138 for PCR value updates due to boots, by regularly submitting API calls to the baseboard management controller 134. The firmware measuring agent 127 may submit an API call to the baseboard management controller 134 to store PCR values 151 in the secure repository 138 responsive to the conclusion of a boot of the managed node 110-1.

In accordance with example implementations, the baseboard management controller 134 may execute a set of firmware instructions, called a “firmware management stack,” for purposes of providing a variety of management services for the host 112 as part of the baseboard management controller's management plane. As examples, the baseboard management controller 134 may provide such management services as monitoring sensors; monitoring operating system status; monitoring power statuses; logging computer system events; providing a remote console; providing remotely-controlled functions and other virtual presence technologies; and other management activities. The management services that are provided by the baseboard management controller 134 may include remotely-management functions, i.e., functions that may be managed by a remote management server. As examples, the remotely-managed functions may include keyboard video mouse (KVM) functions; virtual power functions (e.g., remotely activated functions to remotely set a power state, such as a power conservation state, a power on, a reset state or a power off state); and virtual media management functions.

In accordance with example implementations, the baseboard management controller 134 includes one or multiple main management hardware processing cores 146, such as CPU cores, that execute machine-readable instructions to provide management services for the host 112. These instructions may correspond to a firmware management stack of the baseboard management controller 134. In accordance with some implementations, the processing cores 146 may execute machine-readable instructions that are validated and loaded into a main memory 142 of the baseboard management controller 134 by a security processor 139 of the baseboard management controller 129. The security processor 139, in accordance with example implementations, provides security services that are part of the baseboard management controller's security plane, which is isolated from the baseboard management controller's management plane.

The management services that are provided by the baseboard management controller 134 are part of the baseboard management controller's management plane. In accordance with example implementations, the baseboard management controller 134 may also provide security plane, which is isolated from the baseboard management controller's management plane. Using its security plane, the baseboard management controller 134 may provide various security services (e.g., secure storage for cryptographic security parameters, cryptographic services, cryptographic key sealing and unsealing, and other security services) for the managed node 110-1. In accordance with some implementations, the baseboard management controller 134 may contain the silicon root of trust (SROT) engine 140, which corresponds to the root of trust for measurement of the chain of trust for the managed node 110-1. The SROT engine 140, in accordance with some implementations, may in response to the power up or reset of the managed node 110-1, measure, load and execute initial security service-related firmware for the baseboard management controller 134 to begin a measured boot of the managed node 110-1.

As used herein, a “baseboard management controller” is a specialized service processor that monitors the physical state of a server or other hardware using sensors and communicates with a management system through a management network. The baseboard management controller may communicate with applications executing at the operating system level through an input/output controller (IOCTL) interface driver, a representational state transfer (REST) application program interface (API), or some other system software proxy that facilitates communication between the baseboard management controller and applications. The baseboard management controller may have hardware level access to hardware devices located in a server chassis including system memory. The baseboard management controller may be able to directly modify the hardware devices. The baseboard management controller may operate independently of the operating system of the managed node 110-1. The baseboard management controller may be located on the motherboard or main circuit board of the server or other device to be monitored.

The fact that a baseboard management controller is mounted on a motherboard of the managed server/hardware or otherwise connected or attached to the managed server/hardware does not prevent the baseboard management controller from being considered “separate” from the server/hardware. As used herein, a baseboard management controller has management capabilities for sub-systems of a computing device, and is separate from a processing resource that executes an operating system of a computing device. As such, the baseboard management controller 134 of the managed node 110, as an example, is separate from the host processor(s) 114, which execute the high-level operating system for the managed node 110-1.

In accordance with example implementations, the central resources 180 may include one or multiple management nodes 182. In general, a management node 182 is a processor-based entity that has an associated set of hardware and software resources. In an example, the management node 182 may be a physical computer platform. In another example, the management node 182 may correspond to a smart I/O peripheral. In another example, the management node 182 may be a virtual node (e.g., a virtual machine). Regardless of its particular form, in accordance with example implementations, a management node 182 is associated with one or multiple hardware processors 184 (e.g., one or multiple CPU processing cores and/or GPU processing cores) and a system memory 186 (e.g., non-transitory storage devices). In accordance with example implementations, the system memory 186 may store machine-readable instructions 188. The machine-readable instructions 188, when executed by the hardware processor(s) 184, may provide one or multiple cloud-based management services, such as the start verification service 187 and the update management service 189.

A system administrator, in accordance with example implementations, may provide inputs (e.g., inputs provided by file uploads, keystrokes, touch gestures, mouse movements, graphical user interface (GUI) selections and/or other input mechanisms) to the central resources 180 for purposes of setting up parameters to guide and regulate the start verification service 187 and the update management service 189. For such purposes, a system administrator may, for example, interact with a GUI 159 (e.g., a dashboard) that is served by the central resources 180. In this manner, the GUI 159 allows a system administrator to view output (e.g., managed node statuses, management states, profiles, inventories, configurations, start value verification results, and other information) that is provided by the central resources 180 and provide input (e.g., managed node update authorizations, responsive action selections, configuration options and other parameters) to the central resources 180. In an example, a system administrator may access the GUI 159 via an Internet browser or other software that executes on an administrative node 158.

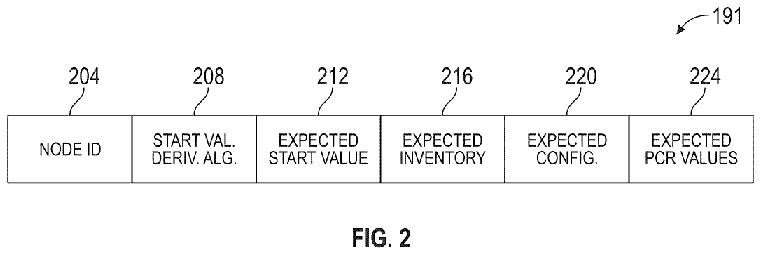

Referring to FIG. 2, in accordance with example implementations, a record 191 for a particular managed node may include a field 204 that contains data representing a managed node identifier. Moreover, the record 191 may contain a field 208 that contains data that identifies a particular state value derivation algorithm that is associated with the managed node. The start verification service may apply the identified state value derivation algorithm to the observed PCR values for a managed node for purposes of generating an observed start value for the managed node. The start verification service may also apply the identified state value derivation algorithm to expected PCR values for the managed node for purposes of generating an expected start value for the managed node.

As also depicted in FIG. 2, the record 191 may include a field 212 that contains data that represents an expected start value for the managed node. In an example, the start verification service may generate an expected start value for a particular managed node based on an expected inventory and an expected configuration for the managed node. The expected start value may then not change until an authorized update is made to the managed node or the start value derivation algorithm for the managed node changes.

The record 191 may further include a field 216 that contains data that represents an expected inventory of the managed node. In another example, the field 216 may contain data that represents a reference, or pointer, to a data structure that contains data that represents an expected inventory of the managed node. Moreover, the record 191 may include a field 220 that contains data that represents an expected configuration for the managed node. In another example, the field 220 may contain data that represents a pointer to a data structure that contains data that represents an expected configuration for the managed node.

In accordance with some implementations, the record 191 may contain a field 224 that represents expected PCR values for the managed node. In another example, the field 224 may contain data that represents a pointer to a data structure that contains data that represents expected PCR values for the managed node. If an authorized update is made to the managed node, then the start verification service may update the particular PCR value(s) that are affected by the authorized update and correspondingly update the expected PCR values. The start verification service may then recalculate the expected start value based on the recalculated expected PCR values and then update the field 212 with the recalculated expected start value.

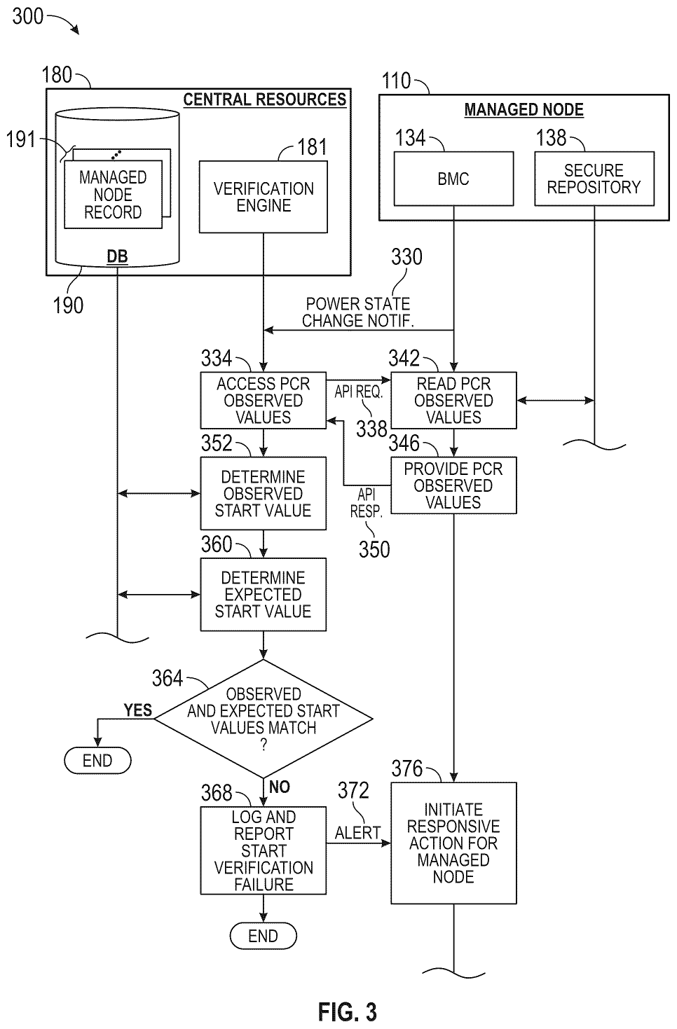

FIG. 3 is a sequence flow diagram 300 depicting communications and actions associated with detecting and managing managed node changes, in accordance with example implementations. As depicted in FIG. 3, in accordance with example implementations, the baseboard management controller 134 of the managed node 110 may provide a notification 330 to the verification engine 181 in response to the managed node 110 changing power states. In this manner, changing the power states involves the managed node 110 booting, and as part of the boot, the managed node 110 acquires integrity measurements and correspondingly provides observed PCR values.

As depicted at 334, the verification engine 181 responds to the power state change notification 330 for purposes of accessing observed PCR values of the managed node 110. For this purpose, the verification engine 181 submits an API request 338 to the baseboard management controller 134. In an example, the API request 338 requests data from a secure repository 138 of the managed node 110 corresponding to the observed PCR values. In an example, the baseboard management controller 134 responds to the API request 338 to read the observed PCR values from the secure repository 138, as depicted at 342. Moreover, for this example, the baseboard management controller 134 provides the observed PCR values, as depicted at 346, by responding to the API request 338 in the form of an API response 350.

As depicted at 352, the verification engine 181 may then determine an observed start value for the managed node 110. For this purpose, the verification engine 181 may access a record 191 of the database(s) 190 corresponding to the managed node 110. From the accessed record 191, the verification engine 181 may identify the start value derivation algorithm corresponding to the managed node 110. In this manner, by applying the start value derivation algorithm to the observed PCR values retrieved from the secure repository 138, the verification engine 181 may determine the observed start value.

As depicted at 360, the verification engine 181 may further determine an expected start value for the managed node 110. For this purpose, in accordance with example implementations, the verification engine 181 may determine the expected start value from the record 191 for the managed node 110. As depicted at decision block 364, the verification engine 181 may then compare the observed and expected start values to determine whether the values are identical. If so, then the managed node has not unexpectedly changed, and the sequence 300 ends. Otherwise, as depicted at 368, the verification engine 181 logs and reports the start verification failure.

In accordance with some implementations, the verification engine 181 may then initiate one or multiple responsive actions to counter potential tampering activity with the managed node 110. In the specific example depicted in FIG. 3, the verification engine 181 sends an alert 372 to the baseboard management controller 134. In accordance with example implementations, the baseboard management controller 134 may then initiate, as depicted at 376, one or multiple responsive actions for the managed node 110.

A “responsive action,” in the context that is used herein, refers to a measure to counter actual or potential tampering activity. In an example, a responsive action may include powering down the managed node. In another example, a responsive action may include powering down the managed node and locking a subsequent reboot of the managed node so that the node is not allowed to reboot until an appropriate administrative credential (a password, key or other credential) is provided. In another example, a responsive action may include generating data for purposes of generating an alert for an administrative dashboard. In another example, a responsive action may include sending an alert message to a system administrator. In another example, a responsive action may include sending an alert message to a remote management server. In another example, a responsive action may include quarantining the managed node from a network external to the node. In another example, a responsive action may include quiescing operations of the managed node associated with an external entity. In accordance with some implementations, the baseboard management controller 134 may select one or multiple responsive action(s) for initiation based on a predefined policy that defines responsive actions and criteria for triggering the responsive actions.

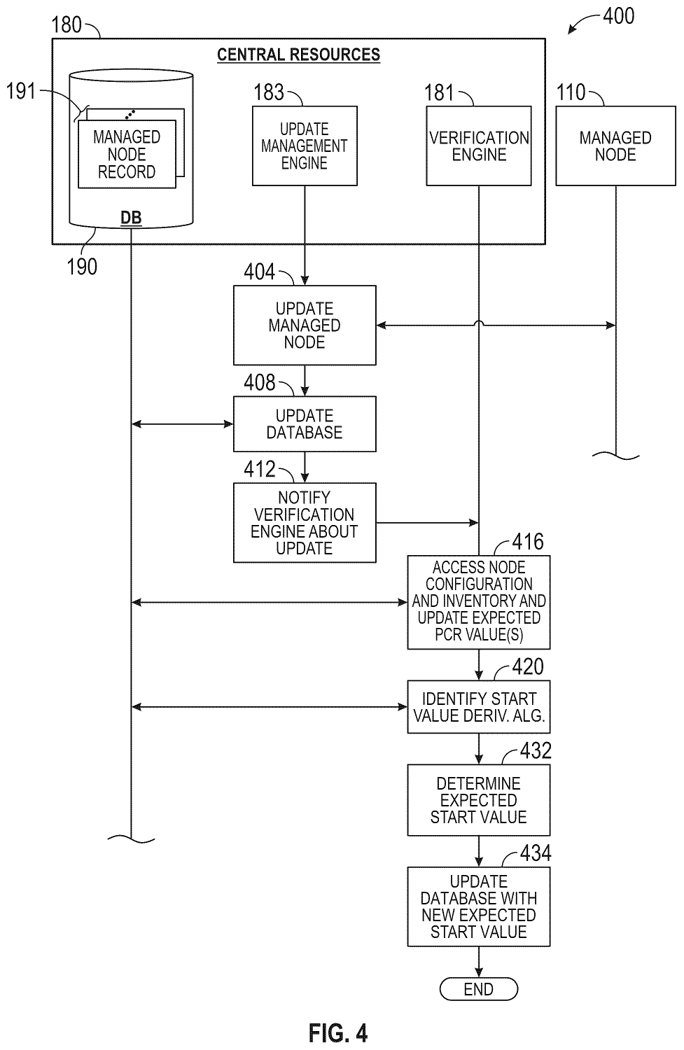

FIG. 4 depicts a sequence flow diagram 400 illustrating communications and actions associated with determining and updating a new expected start value for a managed node. Referring to FIG. 4, an update management engine 183 may update a managed node 110, as depicted at 404. The update, for this example, is an authorized update. In an example, the update may be a firmware upgrade to the managed node 110. In another example, the update may be related to a hardware modification of the managed node 110. In another example, the update may be a configuration change for the managed node 110.

After the update to the managed node 110, the update management engine 183 may then update the database(s) 190, as depicted at 408. In an example, the update may include modifying a configuration represented by a corresponding record 191 for the managed node 110. In another example, the update may involve modifying a corresponding configuration record 191 to reflect an inventory change for the managed node 110. The update management engine 183 may then notify the verification engine 181 about the authorized update, as depicted at 412.

Responsive to the notification, the verification engine 181 may then access the node configuration and inventory, as depicted at 416. In an example, this access may include accessing the corresponding record 191 for the managed node 110. The verification engine 181 may then identify the start value derivation algorithm for the managed node, as depicted at 420.

The verification engine 181 may then determine a new expected start value for the managed node 110, as depicted at 432. In an example, the verification engine 181 may identify the attribute of attributes of the managed node 110 that have been updated and identify the particular expected PCR values that are affected. The verification engine 181 may then recalculate the expected PCR values. The verification engine 181 may then apply the start value derivation algorithm to the expected PCR measurements to determine the corresponding expected start value. The verification engine 181 may then, as depicted at 434, update the database(s) 190 with the new expected start value.

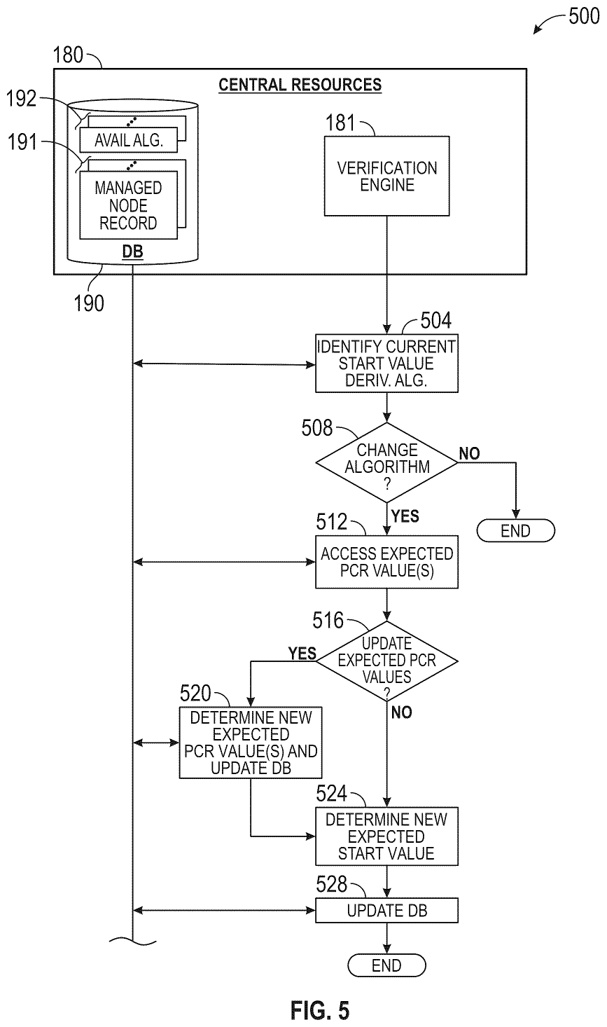

FIG. 5 depicts a sequence flow diagram 500 illustrating communications and actions associated with changing the start value derivation algorithm for a managed node in accordance with example implementations. Referring to FIG. 5, the verification engine 181 may, as depicted at 504, identify the current start derivation algorithm for a particular managed node. In an example, the identification of the current verified start derivation algorithm may be performed periodically or pursuant to another schedule for the managed nodes for purposes of identifying which algorithms should be updated. In an example, new verified start derivation algorithms may become available for the start verification service over time. Newer verified start derivation algorithms may, for example, offer higher degrees of security for the managed nodes. In an example, newer verified start derivation algorithms may address changes to the managed nodes and managed node architecture and may accommodate technology improvements.

Pursuant to decision block 508, the verification engine 181 determines whether the start value derivation algorithm for the particular managed node should be updated, or changed. In an example, the verification engine 181 may select an appropriate start value derivation algorithm out of multiple candidate, or available, start value derivation algorithms (represented by data 192) based on one or multiple attributes of the managed node. If the selected start value derivation algorithm is different from the existing start value derivation algorithm, then the existing start value derivation algorithm is replaced with this new algorithm. The particular attributes of the managed node that are considered for the start value derivation algorithm selection criteria as well as the selection criteria may change over time.

In an example, an attribute considered for start value derivation algorithm selection may be a BIOS version of the managed node, and the selection criteria may identify a particular start value derivation algorithm based on the BIOS version. In an example, the selection criteria may specify that start value derivation algorithm version 3.1.C is to be used for BIOS version 3. In another example, the selection criteria may specify that start value derivation algorithm version 1.0.A is to be used for BIOS version 1. In another example, an attribute considered for start value derivation algorithm selection may be a baseboard management controller version, and the selection criteria may identify a particular start value derivation algorithm based on the version of the managed node's baseboard management controller.

In another example, an attribute considered for start value derivation algorithm selection may be a particular firmware driver version (e.g., a UEFI driver version), the selection criteria may identify a particular start value derivation algorithm based on the managed node's firmware driver version. In another example, an attribute considered for start value derivation algorithm selection may be a particular firmware application version (e.g., a UEFI application version), the selection criteria may identify a particular start value derivation algorithm based on the managed node's firmware application version. In another example, an attribute considered for start value derivation algorithm selection may be a model or version of the managed node, and the selection criteria may identify a particular start value derivation algorithm based on the model or version of the managed node. In other examples, the attributes considered start value derivation algorithm selection criteria may be multidimensional, and the selection criteria may map attribute tuples to different start value derivation algorithms. In an example, the selection criteria may map the managed node's model, BIOS version and baseboard management controller version to a particular start value derivation algorithm. In another example, the selection criteria may map a particular security policy version for the managed node to a particular start value derivation algorithm. In another example, the selection criteria may map a particular hardware processor category (e.g., a processor family, model number or version number) to a particular start value derivation algorithm.

If the existing start value derivation algorithm is to be replaced with a new start value derivation value, then the expected start value for the managed node changes. Accordingly, the verification engine 181, as depicted at 512, accesses the expected PCR values for the managed node. Moreover, as depicted at decision block 516, the verification engine 181 may determine whether to update any expected PCR values for the managed node. In an example, one or multiple authorized changes for the managed node may have recently occurred and may not be reflected in the database record 191. If so, then, as depicted at 520, the verification engine 181 determines the new expected PCR value(s) and updates the database(s) 190. The verification engine 181 may then determine the new expected start value, as depicted at 524. Moreover, the verification engine 181 may then update the database(s) 190, as depicted at 528. In an example, this update may include updating the corresponding record 191 for the managed node to associate the managed node with the new start value derivation algorithm and further associate the managed node with any new expected PCR value(s).

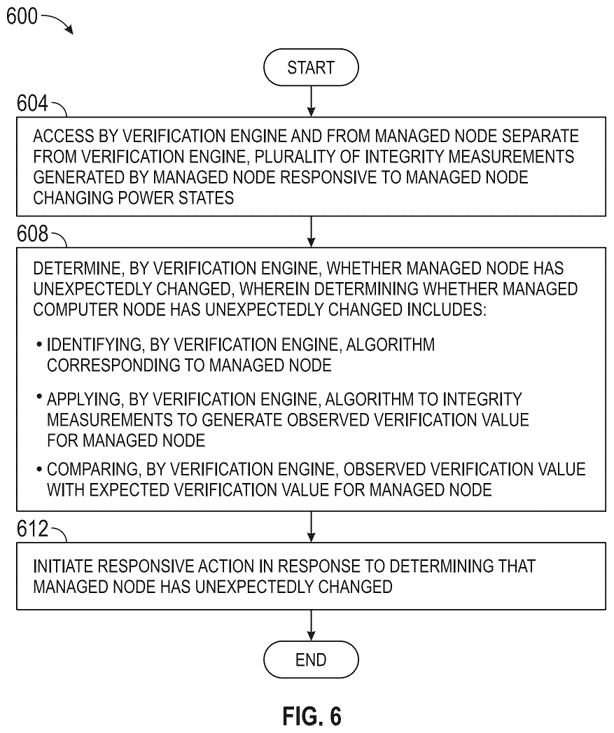

Referring to FIG. 6, in accordance with example implementations, a process 600 includes accessing (block 604), by a verification engine and from a managed node that is separate from the verification engine, a plurality of integrity measurements. The integrity measurements are generated by the managed node responsive to the managed node changing power states. In an example, the integrity measurements may be PCR values. In an example, changing power states may include the managed node booting. In an example, the verification engine may be associated with a cloud-based service. In an example, the verification engine may be associated with an SaaS. In an example, the managed node may correspond to a computer platform. In an example, the managed node may be a server. In an example, the managed node may be virtual.

The process 600 includes detecting (block 608) by the verification engine, whether the managed node has unexpectedly changed. Detecting whether the managed node has unexpectedly changed includes identifying, by the verification engine, an algorithm that corresponds to the managed node. In an example, the managed node may have unexpectedly changed due to a security attack. In an example, the managed node may have unexpectedly changed due to an unauthorized update being made to the managed node. In an example, the algorithm may combine content from PCRs of selected PCR indices. In an example, the algorithm may be associated with a particular hash algorithm. In an example, the verification engine may apply different algorithms for different managed nodes.

Detecting whether the managed node has unexpectedly changed includes applying, by the verification engine, the algorithm to the plurality of integrity measurements to generate an observed verification value for the managed node. In an example, applying the algorithm to the integrity measurements includes concatenating the integrity measurements. In an example, applying the algorithm to the integrity measurements includes determining one or multiple hashes.

Detecting whether the managed node has unexpectedly changed includes comparing, by the verification engine, the observed verification value with an expected verification value for the managed node. In an example, the managed node may determine the expected verification value using the identified algorithm. In an example, the verification engine may apply the algorithm to expected integrity measurements for the managed node. In an example, the verification engine may derive the expected integrity measurements based on an expected inventory for the managed node. In an example, the verification engine may derive the expected integrity measurements based on an expected configuration for the managed node. In an example, the verification engine may communicate with an update management service for the managed node for purposes of tracking authorized updates to an inventory and/or configuration of the managed node. In an example, the expected integrity measurements may be expected PCR values for the managed node. In an example, the verification engine may update the expected verification value responsive to an authorized update being made to the managed node.

The process 600 includes, pursuant to block 612, initiating a responsive action in response to detecting that the managed node has unexpectedly changed. In an example, the responsive action may counter actual or potential tampering activity with the managed node. In an example, a responsive action may include powering down the managed node. In an example, a responsive action may include powering down the managed node and locking a subsequent reboot of the managed node so that the node is not allowed to reboot until an appropriate administrative credential is provided. In an example, a responsive action may include generating data for purposes of generating an alert for an administrative dashboard. In another example, a responsive action may include sending an alert message to a system administrator. In another example, a responsive action may include sending an alert message to a remote management server. In another example, a responsive action may include quarantining the managed node from a network that is external to the node. In another example, a responsive action may include quiescing operations of the managed node associated with an external entity. In an example, a management controller of the managed node, such as a baseboard management controller, may select one or multiple responsive actions for initiation based on a predefined policy that defines responsive actions and criteria for triggering the responsive actions.

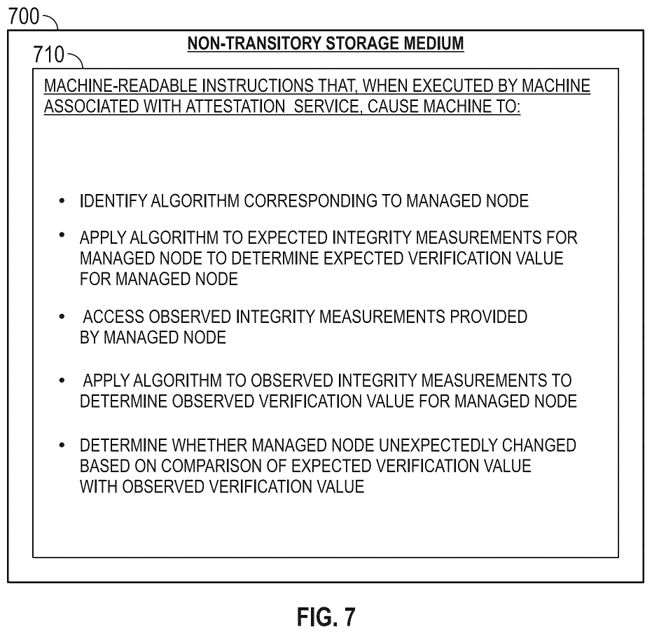

Referring to FIG. 7, in accordance with example implementations, a non-transitory storage medium 700 stores machine-readable instructions 710. The instructions 710, when executed by a machine that is associated with an attestation service, cause the machine to select an algorithm corresponding to the managed node. In an example, selecting the algorithm may include searching a database for a record that corresponds to the managed node and contains data identifying the algorithm. In an example, the attestation service may be an SaaS. In an example, the managed node may be a server. In an example, the managed node may be a computer platform. In an example, the managed node may be virtual.

The instructions 710, when executed by the machine, further cause the machine to apply the algorithm to expected integrity measurements for the managed node to determine an expected verification value for the managed node. In an example, the expected integrity measurements may be expected PCR values for the managed node. In an example, the expected integrity measurements may be hashes. In an example, applying the algorithm to the expected integrity measurements includes combining selected integrity measurements corresponding to selected PCR indices of the managed nodes to derive the expected verification value.

The instructions 710, when executed by the machine, further cause the machine to access observed integrity measurements that are provided by the managed node; and apply the algorithm to the observed integrity measurements to determine an observed verification value for the managed node. In an example, the observed integrity measurements may be PCR values associated with a boot of the managed node. In an example, applying the algorithm to the observed integrity measurements includes applying the algorithm to combine PCR values corresponding to selected PCR values to derive the observed verification value.

The instructions 710, when executed by the machine, further cause the machine to determine whether the managed node unexpectedly changed based on a comparison of the expected verification value with the observed verification value. In accordance with example implementations, determining whether the managed node has unexpectedly changed includes determining whether the observed verification value is the same as the expected verification value. In an example, determining whether the managed node unexpectedly changed includes determining that the observed verification value is different from the expected verification value.

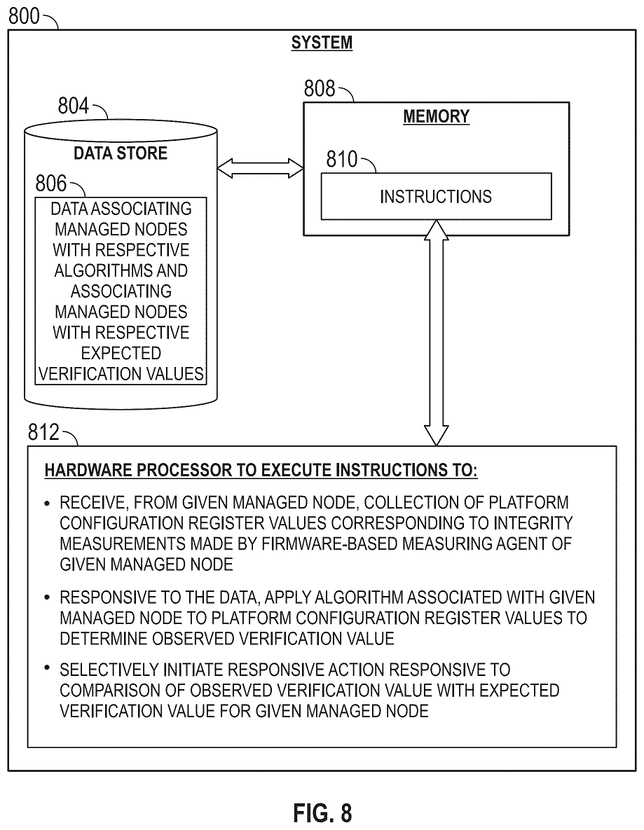

Referring to FIG. 8, in accordance with example implementations, a system 800 includes a data store 804; a memory 808 and a hardware processor 812. The data store 804 stores data associating managed nodes that are managed by a management service with respective algorithms. The data store 804 further associates the managed nodes with respective expected verification values. In examples, the hardware processor 812 may include one or multiple CPU cores. In examples, the hardware processor 812 may include one or multiple GPU cores. In an example, a managed node may be a computer platform. In an example, managed node may be virtual. In an example, an algorithm may correspond to a function to combine integrity measurements of a managed node to derive a start value for the node. In an example, an algorithm may correspond to a function to combine PCR values corresponding to specific PCR indices to derive a start value for the node.

The hardware processor 806, responsive to executing the instructions 810, receives, from a given managed node, a collection of platform configuration register values corresponding to integrity measurements made by a firmware measuring agent of the given managed node. In an example, the firmware measuring agent may acquire the integrity measurements responsive to a boot of the managed node. The hardware processor 806, responsive to executing the instructions 810, further, responsive to the data stored in the data store 804, further applies the algorithm associated with the given managed node to the platform configuration register values to determine an observed verification value.

The hardware processor 812, responsive to executing the instructions 810, further selectively initiates a responsive action responsive to a comparison of the observed verification value with an expected verification value associated with the given managed node. In an example, the hardware processor 812 initiates a responsive action responsive to the observed verification value not matching the expected verification value. In an example, the responsive action may counter actual or potential tampering activity with the managed node. In an example, a responsive action may include powering down the managed node. In an example, a responsive action may include powering down the managed node and locking a subsequent reboot of the managed node so that the node is not allowed to reboot until an appropriate administrative credential is provided. In an example, a responsive action may include generating data for purposes of generating an alert for an administrative dashboard. In another example, a responsive action may include sending an alert message to a system administrator. In another example, a responsive action may include sending an alert message to a remote management server. In another example, a responsive action may include quarantining the managed node from a network that is external to the node. In another example, a responsive action may include quiescing operations of the managed node associated with an external entity. In an example, a management controller of the managed node, such as a baseboard management controller, may select one or multiple responsive actions for initiation based on a predefined policy that defines responsive actions and criteria for triggering the responsive actions.

In accordance with example implementations, the integrity measurements include platform configuration register (PCR) values. A particular advantage is that an attestation service may accurately and efficiently track authorized updates to a managed node.

In accordance with example implementations, an expected verification value is determined. Determining the expected verification value includes determining an expected inventory for the managed node and determining inputs corresponding to the expected inventory. Determining the expected verification value includes applying the algorithm to the inputs to determine the expected verification value. A particular advantage is that an attestation service may accurately and efficiently track authorized updates to a managed node.

In accordance with example implementations, determining the expected inventory includes determining an expected firmware image for the managed node. Determining the inputs includes determining a hash value based on the expected firmware image. A particular advantage is that an attestation service may accurately and efficiently track authorized updates to a managed node.

In accordance with example implementations, determining the expected inventory includes determining an expected image corresponding to a firmware application or driver for the managed node. Determining the inputs includes determining a hash value based on the expected image. A particular advantage is that an attestation service may accurately and efficiently track authorized updates to a managed node.

In accordance with example implementations, determining the expected inventory includes determining an expected firmware image of a peripheral for the compute node. Determining the inputs includes determining a hash value based on the expected firmware image. A particular advantage is that an attestation service may accurately and efficiently track authorized updates to a managed node.

In accordance with example implementations, determining the expected inventory includes determining an expected configuration for the compute node, wherein determining the inputs includes determining a hash value based on the expected configuration. A particular advantage is that an attestation service may accurately and efficiently track authorized updates to a managed node.

In accordance with example implementations, determining the expected inventory includes determining an expected secure boot policy for the compute node. Determining the inputs includes determining a hash value based on the expected secure boot policy. A particular advantage is that an attestation service may accurately and efficiently track authorized updates to a managed node.

In accordance with example implementations, determining the expected verification value includes determining an expected inventory for the compute node and determining expected platform configuration register contents for the managed nodes based on the expected inventory. Determining the expected verification value includes applying the algorithm to the platform configuration register contents to determine the expected verification value. A particular advantage is that an attestation service may accurately and efficiently track authorized updates to a managed node.

In accordance with example implementations, initiating the responsive action includes at least one of causing the managed node to be powered down, imposing a credential to be provided before the managed node can be rebooted, causing an alert to be provided to an administrative dashboard, causing an alert to be sent to a system administrator, causing an alert to be sent to a remote management server, causing the managed node to be quarantined from a network, or causing operations of the managed node associated with an external entity to be quiesced. A particular advantage is that an attestation service may timely initiate a responsive action to counter tampering with a managed node.

The detailed description set forth herein refers to the accompanying drawings. Wherever possible, the same reference numbers are used in the drawings and the foregoing description to refer to the same or similar parts. It is to be expressly understood, however, that the drawings are for the purpose of illustration and description only. While several examples are described in this document, modifications, adaptations, and other implementations are possible. Accordingly, the detailed description does not limit the disclosed examples. Instead, the proper scope of the disclosed examples may be defined by the appended claims.

The terminology used herein is for the purpose of describing particular examples only and is not intended to be limiting. As used herein, the singular forms “a,” “an,” and “the” are intended to include the plural forms as well, unless the context clearly indicates otherwise. The term “plurality,” as used herein, is defined as two or more than two. The term “another,” as used herein, is defined as at least a second or more. The term “connected,” as used herein, is defined as connected, whether directly without any intervening elements or indirectly with at least one intervening elements, unless otherwise indicated. Two elements can be coupled mechanically, electrically, or communicatively linked through a communication channel, pathway, network, or system. The term “and/or” as used herein refers to and encompasses any and all possible combinations of the associated listed items. It will also be understood that, although the terms first, second, third, etc. may be used herein to describe various elements, these elements should not be limited by these terms, as these terms are only used to distinguish one element from another unless stated otherwise or the context indicates otherwise. As used herein, the term “includes” means includes but not limited to, the term “including” means including but not limited to. The term “based on” means based at least in part on.

While the present disclosure has been described with respect to a limited number of implementations, those skilled in the art, having the benefit of this disclosure, will appreciate numerous modifications and variations therefrom. It is intended that the appended claims cover all such modifications and variations.

What is claimed is:

1. A method comprising
accessing, by a verification engine from a managed node separate from the verification engine, a plurality of integrity measurements generated by the managed node responsive to the managed node changing power states;
detecting, by the verification engine, whether the managed node has unexpectedly changed, wherein detecting whether the managed node has unexpectedly changed comprises:
identifying, by the verification engine, an algorithm corresponding to the managed node;
applying, by the verification engine, the algorithm to the plurality of integrity measurements to generate an observed verification value for the managed node; and
comparing, by the verification engine, the observed verification value with an expected verification value for the managed node; and
initiating a responsive action in response to detecting that the managed node has unexpectedly changed.

2. The method of claim 1, wherein the plurality of integrity measurements comprises platform configuration register (PCR) values.

3. The method of claim 1, further comprising determining, by the verification engine, the expected verification value, wherein determining the expected verification value comprises:
determining an expected inventory for the managed node;
determining inputs corresponding to the expected inventory; and
applying the algorithm to the inputs to determine the expected verification value.

4. The method of claim 3, wherein:
determining the expected inventory comprises determining an expected firmware image for the managed node; and
determining the inputs comprises determining a hash value based on the expected firmware image.

5. The method of claim 3, wherein:
determining the expected inventory comprises determining an expected image corresponding to a firmware application or driver for the managed node; and
determining the inputs comprises determining a hash value based on the expected image.

6. The method of claim 3, wherein:
determining the expected inventory comprises determining an expected firmware image of a peripheral for the managed node; and
determining the inputs comprises determining a hash value based on the expected firmware image.

7. The method of claim 3, wherein:
determining the expected inventory comprises determining an expected configuration for the managed node; and
determining the inputs comprises determining a hash value based on the expected configuration.

8. The method of claim 3, wherein:
determining the expected inventory comprises determining an expected secure boot policy for the managed node; and
determining the inputs comprises determining a hash value based on the expected secure boot policy.

9. The method of claim 1, further comprising determining, by the verification engine, the expected value, wherein determining the expected verification value comprises:
determining an expected inventory for the managed node;
determining expected platform configuration register contents for the managed node based on the expected inventory; and
applying the algorithm to the platform configuration register contents to determine the expected verification value.

10. The method of claim 1, further comprising:
responsive to an inventory of the managed node change, replacing the algorithm corresponding to the managed node with a replacement algorithm and applying a second expected verification value based on the replacement algorithm;
accessing, by a verification engine and from the managed node separate from the verification, a second plurality of integrity measurements generated by the managed node responsive to the managed node changing power states;
applying, by the verification engine, the replacement algorithm to the second plurality of integrity measurements to generate a second observed verification value for the managed node;
comparing the second observed verification value with the second expected verification value for the managed node; and
determining whether the managed node has unexpectedly changed responsive to the comparison of the second observed verification value with the second expected verification value.

11. The method of claim 1, wherein initiating the responsive action comprises at least one of causing the managed node to be powered down, imposing a credential to be provided before the managed node can be rebooted, causing an alert to be provided to an administrative dashboard, causing an alert to be sent to a system administrator, causing an alert to be sent to a remote management server, causing the managed node to be quarantined from a network, or causing operations of the managed node associated with an external entity to be quiesced.

12. A non-transitory storage medium that stores machine-readable instructions that, when executed by a machine associated with an attestation service, cause the machine to:
identify an algorithm corresponding to the managed node;
apply the algorithm to expected integrity measurements for the managed node to determine an expected verification value for the managed node;
access observed integrity measurements provided by the managed node;
apply the algorithm to the observed integrity measurements to determine an observed verification value for the managed node; and
determine whether the managed node unexpectedly changed based on a comparison of the expected verification value with the observed verification value.

13. The storage medium of claim 12, wherein:
the attributes comprise a model identifier corresponding to the managed node;
the instructions, when executed by the machine, further cause the machine to select the algorithm based on the model.

14. The storage medium of claim 12, wherein:
the attributes comprise a hardware processor category;
the instructions, when executed by the machine, further cause the machine to select the algorithm based on the hardware processor category.

15. The storage medium of claim 12, wherein:
the attributes comprise a firmware version; and
the instructions, when executed by the machine, further cause the machine to select the algorithm based on the firmware version.

16. A system associated with a management service, the system comprising:
a repository to a data store associating managed nodes managed by the management service with respective algorithms and associating the managed nodes with respective expected verification values;
a hardware processor; and
a memory to store instructions that, when executed by the hardware processor, cause the hardware processor to:
receive, from a given managed node of the managed nodes, a collection of platform configuration register values corresponding to integrity measurements made by a firmware-based measuring agent of the given managed node;
responsive to the data, apply the algorithm of the algorithms associated with the given managed node to the platform configuration register values to determine an observed verification value; and
selectively initiate a responsive action responsive to a comparison of the observed verification value with an expected verification value for the given managed node.

17. The system of claim 16, wherein the hardware processor to further, in responsive to an update to the given managed node, update the data store to reassociate the managed node with another algorithm and change the verification value associated with the managed node.

18. The system of claim 16, wherein the hardware processor to further, communicate with a baseboard management controller of the given managed node to receive the collection of platform register configuration values.

19. The system of claim 16, wherein the hardware processor to further:
responsive to an authorized update being made to the managed node, update the expected verification value.

20. The system of claim 19, wherein the hardware processor to further:
identify an image associated with the given managed node responsive to the authorized update;
determine an integrity measurement corresponding to the image; and
update the expected verification value based on the integrity measurement corresponding to the image.
